(19) United States
(12) Patent Application Publication
(10) Pub. No.: US 2026/0021602 A1
(43) Pub. Date: Jan. 22, 2026

(54) COMPLEX FACILITY AND FACILITY LAYOUT

(71) Applicant: SK ON CO., LTD., Seoul (KR)

(72) Inventor: Do Heon KIM, Daejeon (KR)

(21) Appl. No.: 19/250,105

(22) Filed: Jun. 26, 2025

(30) Foreign Application Priority Data
Jul. 19, 2024 (KR) 10-2024-0095858
Nov. 20, 2024 (KR) 10-2024-0166378

(51) Int. Cl. B26D 3/14; H01M 10/04

(52) U.S. Cl. CPC B26D 3/14; H01M 10/0404

(57) ABSTRACT

Proposed are a complex facility and a facility layout. The complex facility includes a positive electrode manufacturing machine, a negative electrode manufacturing machine, a positive electrode first direction transferring machine, a negative electrode first direction transferring machine, at least one positive electrode second direction transferring machine, at least one negative electrode second direction transferring machine, at least one first stacker, and at least one second stacker. The facility layout includes a plurality of complex facilities.

### CROSS REFERENCE TO RELATED APPLICATION

The present application claims priority to Korean Patent Application No. 10-2024-0095858, filed Jul. 19, 2024, and Korean Patent Application No. 10-2024-0166378, filed Nov. 20, 2024, the entire contents of which are incorporated herein for all purposes by this reference.

### TECHNICAL FIELD

The present disclosure relates to a complex facility and a facility layout.

### BACKGROUND

A secondary battery is capable of being charged and discharged. The secondary battery is used in an electric vehicle, an Energy Storage System (ESS), a portable electronic device, and so on. The secondary battery is formed in a structure in which an electrode assembly formed by stacking a negative electrode, a separator, and a positive electrode is immersed in an electrolyte solution and stored in a casing. The electrode assembly may be formed by coating, notching, and stacking. Notching is a process in which a tab is formed by cutting a current collector of a negative electrode or a positive electrode. Stacking is a process in which an electrode assembly is formed by stacking a negative electrode, a separator, and a positive electrode.

### SUMMARY

According to an aspect of the present disclosure, there is provided a complex facility in which a notching facility and a stacking facility are configured as one facility.

According to an aspect of the present disclosure, there is provided a facility layout in which a plurality of complex facilities efficiently uses a space.

The complex facility and the facility layout according to an aspect of the present disclosure may be applied to a manufacturing process of a battery widely used in green technology fields such as electric vehicles, battery charging stations, and other fields using a battery, such as the solar photovoltaic power generation field, the wind power generation field, and so on.

The complex facility and the facility layout according to an aspect of the present disclosure may be applied to a manufacturing process of a battery used in an eco-friendly electric vehicle, a hybrid vehicle, and so on for preventing climate change by suppressing air pollution and the emission of greenhouse gases.

According to an aspect of the present disclosure, there is provided a complex facility including: a positive electrode manufacturing machine configured to form a positive electrode by forming and cutting a tab on a positive electrode sheet that travels in a first direction; a negative electrode manufacturing machine configured to form a negative electrode by forming and cutting a tab on a negative electrode sheet that travels in the first direction, the negative electrode manufacturing machine being disposed parallel to the positive electrode manufacturing machine; a positive electrode first direction transferring machine configured to transfer the positive electrode in the first direction, the positive electrode being output from the positive electrode manufacturing machine; a negative electrode first direction transferring machine configured to transfer the negative electrode in the first direction, the negative electrode being output from the negative electrode manufacturing machine; at least one first stacker positioned on an opposite side of the negative electrode first direction transferring machine with respect to the positive electrode first direction transferring machine and configured to form an electrode assembly by stacking the positive electrode, a separator, and the negative electrode; at least one second stacker positioned on an opposite side of the positive electrode first direction transferring machine with respect to the negative electrode first direction transferring machine and configured to form the electrode assembly by stacking the positive electrode, the separator, and the negative electrode; at least one positive electrode second direction transferring machine configured to transfer the positive electrode transferred from the positive electrode first direction transferring machine in a second direction and to supply the positive electrode to the first stacker and the second stacker; and at least one negative electrode second direction transferring machine configured to transfer the negative electrode transferred from the negative electrode first direction transferring machine in the second direction and to supply the negative electrode to the first stacker and the second stacker.

According to an aspect of the present disclosure, the positive electrode manufacturing machine may include: a positive electrode notching machine configured to form the tab on the positive electrode sheet that travels in the first direction; and a positive electrode cutter configured to form the positive electrode by cutting the positive electrode sheet on which the tab is formed.

According to an aspect of the present disclosure, the negative electrode manufacturing machine may include: a negative electrode notching machine configured to form the tab on the negative electrode sheet that travels in the first direction; and a negative electrode cutter configured to form the negative electrode by cutting the negative electrode sheet on which the tab is formed.

According to an aspect of the present disclosure, the complex facility may further include: a positive electrode unwinder configured to supply the positive electrode sheet to the positive electrode manufacturing machine by unwinding a positive electrode sheet roll in the first direction; and a negative electrode unwinder configured to supply the negative electrode sheet to the negative electrode manufacturing machine by unwinding a negative electrode sheet roll in the first direction.

According to an aspect of the present disclosure, the complex facility may further include: a positive electrode roll changer configured to discharge a depleted positive electrode sheet roll and to replace the depleted positive electrode sheet roll with a new positive electrode sheet roll when the positive electrode sheet roll in the positive electrode unwinder is depleted; and a negative electrode roll changer configured to discharge a depleted negative electrode sheet roll and to replace the depleted negative electrode sheet roll with a new negative electrode sheet roll when the negative electrode sheet roll in the negative electrode unwinder is depleted.

According to an aspect of the present disclosure, the positive electrode second direction transferring machine may include: a positive electrode bridge which is positioned between the positive electrode first direction transferring machine and the negative electrode first direction transferring machine and on which the positive electrode is seated; a first positive electrode supplying machine configured to supply the positive electrode on the positive electrode first direction transferring machine to the first stacker and to move another positive electrode on the positive electrode first direction transferring machine to the positive electrode bridge; and a second positive electrode supplying machine configured to supply the positive electrode on the positive electrode bridge to the second stacker.

According to an aspect of the present disclosure, the negative electrode second direction transferring machine may include: a negative electrode bridge which is positioned between the positive electrode first direction transferring machine and the negative electrode first direction transferring machine and on which the negative electrode is seated; a first negative electrode supplying machine configured to supply the negative electrode on the negative electrode first direction transferring machine to the second stacker and to move another negative electrode on the negative electrode first direction transferring machine to the negative electrode bridge; and a second negative electrode supplying machine configured to supply the negative electrode on the negative electrode bridge to the first stacker.

According to an aspect of the present disclosure, the first positive electrode supplying machine may include: a first pickup part configured to pick up the positive electrode on the positive electrode first direction transferring machine and to supply the positive electrode to the first stacker, a second pickup part configured to pick up the positive electrode on the positive electrode first direction transferring machine and to supply the positive electrode to the positive electrode bridge; and a first supplying driving part configured to simultaneously move the first pickup part and the second pickup part in the second direction perpendicular to the first direction.

According to an aspect of the present disclosure, the first negative electrode supplying machine may include: a third pickup part configured to pick up the negative electrode on the negative electrode first direction transferring machine and to supply the negative electrode to the first stacker; a fourth pickup part configured to pick up the negative electrode on the negative electrode first direction transferring machine and to supply the negative electrode to the negative electrode bridge; and a second supplying driving part configured to simultaneously move the third pickup part and the fourth pickup part in the second direction perpendicular to the first direction.

According to an aspect of the present disclosure, the complex facility may further include: a negative electrode floating table which is spaced apart from above the positive electrode first direction transferring machine and on which the negative electrode is seated; and a positive electrode floating table which is spaced apart from above the negative electrode first direction transferring machine and on which the positive electrode is seated.

According to an aspect of the present disclosure, the second positive electrode supplying machine may include: a fifth pickup part configured to pick up the positive electrode on the positive electrode bridge and to move the positive electrode to the positive electrode floating table; a sixth pickup part configured to pick up the positive electrode on the positive electrode floating table and to supply the positive electrode to the second stacker; and a third supplying driving part configured to simultaneously move the fifth pickup part and the sixth pickup part in the second direction perpendicular to the first direction.

According to an aspect of the present disclosure, the second negative electrode supplying machine may include: a seventh pickup part configured to pick up the negative electrode on the negative electrode bridge and to move the negative electrode to the negative electrode floating table; an eighth pickup part configured to pick up the negative electrode on the negative electrode floating table and to supply the negative electrode to the first stacker, and a fourth supplying driving part configured to simultaneously move the seventh pickup part and the eighth pickup part in the second direction perpendicular to the first direction.

According to an aspect of the present disclosure, the complex facility may further include: a negative electrode partition which is positioned between the positive electrode first direction transferring machine and the negative electrode floating table and which extends along a path where the second negative electrode supplying machine moves the negative electrode, the negative electrode partition being configured to prevent negative electrode particles dropping from the negative electrode from dropping on the positive electrode first direction transferring machine; and a positive electrode partition which is positioned between the negative electrode first direction transferring machine and the positive electrode floating table and which extends along a path where the second positive electrode supplying machine moves the positive electrode, the positive electrode partition being configured to prevent positive electrode particles dropping from the positive electrode from dropping on the negative electrode first direction transferring machine.

According to an aspect of the present disclosure, the positive electrode bridge may be configured to move the positive electrode moved by the first positive electrode supplying machine to a position where the second positive electrode supplying machine picks up the positive electrode, and the negative electrode bridge may be configured to move the negative electrode moved by the first negative electrode supplying machine to a position where the second negative electrode supplying machine picks up the negative electrode.

According to an aspect of the present disclosure, the first positive electrode supplying machine may be configured such that the first pickup part and the second pickup part are reciprocated in the second direction by the first supplying driving part so that each operation determined in a first motion section and a second motion section is repeated, and the first negative electrode supplying machine may be configured such that the third pickup part and the fourth pickup part are reciprocated in the second direction by the second supplying driving part so that each operation determined in the first motion section and the second motion section is repeated. Furthermore, in the first motion section, when the first pickup part of the first positive electrode supplying machine picks up the positive electrode on the positive electrode first direction transferring machine, the second pickup part may place the positive electrode on the first stacker at the same time. Furthermore, in the first motion section, when the third pickup part of the first negative electrode supplying machine picks up the negative electrode on the negative electrode first direction transferring machine, the fourth pickup part may place the negative electrode on the second stacker at the same time. In the second motion section, when the first pickup part of the first positive electrode supplying machine places the positive electrode on the positive electrode bridge, the second pickup part may pick up the positive electrode on the positive electrode first direction transferring machine at the same time. Furthermore, in the second motion section, when the third pickup part of the first negative electrode supplying machine places the negative electrode on the negative electrode bridge, the fourth pickup part may pick up the negative electrode on the negative electrode first direction transferring machine at the same time.

According to an aspect of the present disclosure, the second positive electrode supplying machine may be configured such that the fifth pickup part and the sixth pickup part are reciprocated in the second direction by the third supplying driving part so that each operation determined in a first motion section and a second motion section is repeated, and the second negative electrode supplying machine may be configured such that the seventh pickup part and the eighth pickup part are reciprocated in the second direction by the fourth supplying driving part so that each operation determined in the first motion section and the second motion section is repeated. Furthermore, in the first motion section, when the fifth pickup part of the second positive electrode supplying machine picks up the positive electrode on the positive electrode bridge, the sixth pickup part may pick up the positive electrode on the positive electrode floating table at the same time. Furthermore, in the first motion section, when the seventh pickup part of the second negative electrode supplying machine picks up the negative electrode on the negative electrode bridge, the eighth pickup part may pick up the negative electrode on the negative electrode floating table at the same time. Furthermore, in the second motion section, when the fifth pickup part of the second positive electrode supplying machine places the positive electrode on the positive electrode floating table, the sixth pickup part may place the positive electrode on the second stacker at the same time. Furthermore, in the second motion section, when the seventh pickup part of the second negative electrode supplying machine places the negative electrode on the negative electrode floating table, the eighth pickup part may place the negative electrode on the first stacker at the same time.

According to an aspect of the present disclosure, the first positive electrode supplying machine, the positive electrode bridge, and the second positive electrode supplying machine may be disposed on a same line in the second direction, and the first negative electrode supplying machine, the negative electrode bridge, and the second negative electrode supplying machine may be disposed on a same line in the second direction.

According to an aspect of the present disclosure, there is provided a facility layout including: a plurality of complex facilities described above; a plurality of first carriers configured to transfer the electrode assembly manufactured by the first stacker and the second stacker of the plurality of complex facilities in the first direction; and a second carrier configured to receive the electrode assembly transferred by the plurality of first carriers and to transfer the electrode assembly in the second direction.

According to an aspect of the present disclosure, the plurality of complex facilities may be disposed such that the plurality of complex facilities is spaced apart from each other by a predetermined distance along the second carrier that extends in the second direction.

According to an aspect of the present disclosure, the complex facility may further include a roll transferring unit configured to transfer a positive electrode sheet roll or a negative electrode sheet roll to the plurality of complex facilities and to be autonomously driven.

The features and advantages of the present disclosure will be more clearly understood from the following detailed description based on the accompanying drawings.

The terms and words used in the present specification and claims should not be interpreted as being limited to typical meanings and dictionary definitions, but should be interpreted as having meanings and concepts relevant to the technical scope of the present disclosure based on the rule according to which an inventor can appropriately define the concept of the term to describe most appropriately the best method he or she knows for carrying out the present disclosure.

According to an aspect of the present disclosure, defects that occur in a process of transferring an electrode from the notching process to the stacking process may be minimized.

According to an aspect of the present disclosure, a space of a secondary battery manufacturing factory may be efficiently utilized.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view illustrating a complex facility according to an embodiment;

FIG. 2 is a plan view illustrating the complex facility in a first motion section according to an embodiment;

FIG. 3 is a plan view illustrating the complex facility in a second motion section according to an embodiment;

FIG. 4 is a side view illustrating a positive electrode line of the complex facility according to an embodiment;

FIG. 5 is a side view illustrating a negative electrode line of the complex facility according to an embodiment;

FIG. 6 is a view illustrating a rotation type stacker according to an embodiment;

FIG. 7 is a view illustrating a stationary type stacker according to an embodiment;

FIG. 8 is a view illustrating each operation of a first positive electrode supplying machine and a second positive electrode supplying machine in the first motion section and the second motion section according to an embodiment;

FIG. 9 is a view illustrating each operation of a first negative electrode supplying machine and a second negative electrode supplying machine in the first motion section and the second motion section according to an embodiment; and

FIG. 10 is a view illustrating a facility layout according to an embodiment.

### DETAILED DESCRIPTION

Hereinafter, the present disclosure will be described in detail with reference to the accompanying drawings. However, those skilled in the art will appreciate that such embodiments are provided to further understand the spirit of the present disclosure and do not limit subject matters to be protected as disclosed in the detailed description and appended claims.

Hereinafter, an embodiment of the present disclosure will be described in detail with reference to the accompanying drawings.

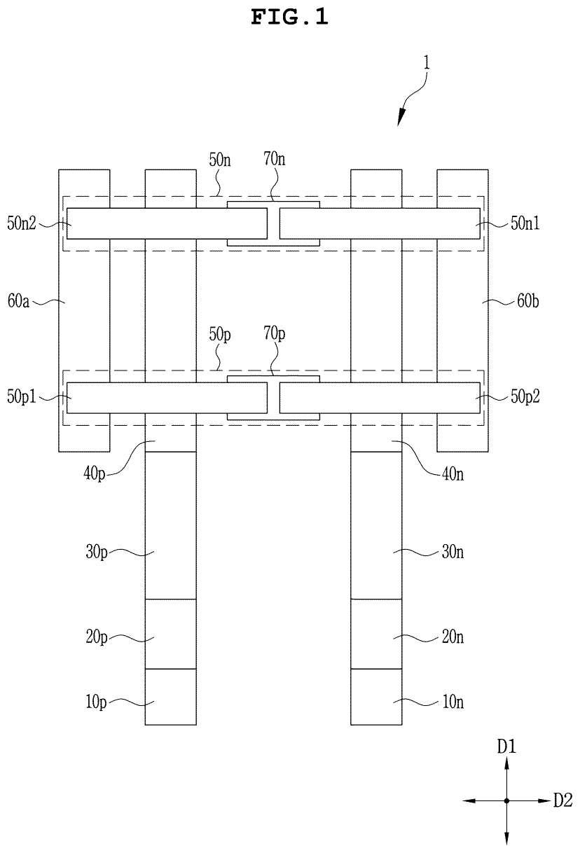

FIG. 1 is a view illustrating a complex facility 1 according to an embodiment.

The complex facility 1 may perform both a notching process and a stacking process in a single flow, wherein the notching process is a process in which an electrode is formed by forming and cutting a tab on an electrode sheet and the stacking process is a process in which an electrode assembly 6 is formed by stacking a negative electrode 5n, a separator 7, and a positive electrode 5p.

The complex facility 1 according to an embodiment may include: a positive electrode manufacturing machine 30p configured to form the positive electrode 5p by forming and cutting a tab on a positive electrode sheet 3p traveling in a first direction D1; a negative electrode manufacturing machine 30n configured to form the negative electrode 5n by forming and cutting a tab on a negative electrode sheet 3n traveling in the first direction D1, the negative electrode manufacturing machine 30n being disposed parallel to the positive electrode manufacturing machine 30p; a positive electrode first direction transferring machine 40p configured to transfer the positive electrode 5p output from the positive electrode manufacturing machine 30p in the first direction D1; a negative electrode first direction transferring machine 40n configured to transfer the negative electrode 5n output from the negative electrode manufacturing machine 30n in the first direction D1; at least one first stacker 60a positioned on an opposite side of the negative electrode first direction transferring machine 40n with respect to the positive electrode first direction transferring machine 40p and configured to form the electrode assembly 6 by stacking the positive electrode 5p, the separator 7, and the negative electrode 5n; at least one second stacker 60b positioned on an opposite side of the positive electrode first direction transferring machine 40p with respect to the negative electrode first direction transferring machine 40n and configured to form the electrode assembly 6 by stacking the positive electrode 5p, the separator 7, and the negative electrode 5n; at least one positive electrode second direction transferring machine 50p configured to transfer the positive electrode 5p transferred from the positive electrode first direction transferring machine 40p in a second direction D2 and to supply the positive electrode 5p to the first stacker 60a and the second stacker 60b; and at least one negative electrode second direction transferring machine 50n configured to transfer the negative electrode 5n transferred from the negative electrode first direction transferring machine 40n in the second direction D2 and to supply the negative electrode 5n to the first stacker 60a and the second stacker 60b.

The complex facility 1 according to an embodiment may further include: a positive electrode unwinder 20p configured to supply the positive electrode sheet 3p to the positive electrode manufacturing machine 30p by unwinding a positive electrode sheet roll 2p in the first direction D1; and a negative electrode unwinder 20n configured to supply the negative electrode sheet 3n to the negative electrode manufacturing machine 30n by unwinding a negative electrode sheet roll 2n in the first direction D1.

The complex facility 1 according to an embodiment may further include: a positive electrode roll changer 10p configured to discharge a depleted positive electrode sheet roll 2p and to replace the depleted positive electrode sheet roll 2p with a new positive electrode sheet roll 2p when the positive electrode sheet roll 2p in the positive electrode unwinder 20p is depleted; and a negative electrode roll changer 10n configured to discharge a depleted negative electrode sheet roll 2n and to replace the depleted negative electrode sheet roll 2n with a new negative electrode sheet roll 2n when the negative electrode sheet roll 2n in the negative electrode unwinder 20n is depleted.

In the complex facility 1, a positive electrode line in which the positive electrode roll changer 10p, the positive electrode unwinder 20p, the positive electrode manufacturing machine 30p, and the positive electrode first direction transferring machine 40p are connected to each other and a negative electrode line in which the negative electrode roll changer 10n, the negative electrode unwinder 20n, the negative electrode manufacturing machine 30n, and the negative electrode first direction transferring machine 40n are connected to each other may be disposed parallel to each other along the first direction D1.

The positive electrode first direction transferring machine 40p and the negative electrode first direction transferring machine 40n may include a conveyor belt, a Linear Motion System (LMS), and other apparatus capable of transferring an electrode. The positive electrode 5p and the negative electrode 5n that are manufactured in the positive electrode manufacturing machine 30p and the negative electrode manufacturing machine 30n may be supplied directly to the positive electrode first direction transferring machine 40p and the negative electrode first direction transferring machine 40n. The positive electrode first direction transferring machine 40p and the negative electrode first direction transferring machine 40n may transfer the positive electrode 5p and the negative electrode 5n in the first direction D1. The positive electrode 5p and the negative electrode 5n that are transferred in the first direction D1 may be supplied to the first stacker 60a and the second stacker 60b by the positive electrode second direction transferring machine 50p and the negative electrode second direction transferring machine 50n.

Since the positive electrode 5p and the negative electrode 5n are not stored in a magazine after the positive electrode 5p and the negative electrode 5n are manufactured, damage that may occur during a process of storing and withdrawing the positive electrode 5p and the negative electrode 5n may not occur to the positive electrode 5p and the negative electrode 5n. For example, various damages such as bending of the positive electrode 5p due to collision between the magazine and an edge of the positive electrode 5p, tearing, cracking of an active material, and so on may occur. The positive electrode 5p and the negative electrode 5n may be moved by the positive electrode first direction transferring machine 40p and the negative electrode first direction transferring machine 40n and then may be supplied to the stackers by the positive electrode second direction transferring machine 50p and the negative electrode second direction transferring machine 50n. Therefore, damage that may occur during a transferring process of the positive electrode 5p and the negative electrode 5n may be minimized.

The first stacker 60a and the second stacker 60b may be disposed on an outer side surface of the positive electrode line and on an outer side surface of the negative electrode line, respectively. Accordingly, a worker may perform a work required for the first stacker 60a and the second stacker 60b from outside of the positive electrode line and the negative electrode line. Specifically, the first stacker 60a may be disposed on the opposite side of the negative electrode first direction transferring machine 40n with respect to the positive electrode first direction transferring machine 40p. The second stacker 60b may be disposed on the opposite side of the positive electrode first direction transferring machine 40p with respect to the negative electrode first direction transferring machine 40n. The positive electrode first direction transferring machine 40p and the negative electrode first direction transferring machine 40n may be disposed between the first stacker 60a and the second stacker 60b.

Since the first stacker 60a and the second stacker 60b are not positioned between the positive electrode line and the negative electrode line but are positioned outside the positive electrode line and the negative electrode line, the worker may easily access the first stacker 60a and the second stacker 60b. The worker may access automation facilities (the positive electrode unwinder 20p, the negative electrode unwinder 20n, the positive electrode roll changer 10p, the negative electrode roll changer 10n, the positive electrode manufacturing machine 30p, the negative electrode manufacturing machine 30n, the first direction transferring machines 40p and 40n, the second direction transferring machines 50p and 50n, the first stacker 60a, and the second stacker 60b) requiring a maintenance work from outside the positive electrode line and the negative electrode line. Since only a positive electrode bridge 70p and a negative electrode bridge 70n are positioned between the positive electrode line and the negative electrode line, a distance between the positive electrode line and the negative electrode line may be reduced. That is, a left and right size (a length in the second direction D2) of the complex facility 1 may be minimized. Accordingly, a movement path of the worker from the outside of the positive electrode line to the outside of the negative electrode line may be minimized. In addition, an area occupied by the complex facility 1 may be reduced, so that an area of an entire manufacturing factory may be reduced. That is, a space of a secondary battery manufacturing factory may be efficiently utilized.

The positive electrode second direction transferring machine 50p may include: the positive electrode bridge 70p which is positioned between the positive electrode first direction transferring machine 40p and the negative electrode first direction transferring machine 40n and on which the positive electrode 5p is seated; a first positive electrode supplying machine 50p1 configured to supply the positive electrode 5p on the positive electrode first direction transferring machine 40p to the first stacker 60a and to move another positive electrode 5p on the positive electrode first direction transferring machine 40p to the positive electrode bridge 70p; and a second positive electrode supplying machine 50p2 configured to supply the positive electrode 5p on the positive electrode bridge 70p to the second stacker 60b.

The negative electrode second direction transferring machine 50n may include: the negative electrode bridge 70n which is positioned between the positive electrode first direction transferring machine 40p and the negative electrode first direction transferring machine 40n and on which the negative electrode 5n is seated; a first negative electrode supplying machine 50n1 configured to supply the negative electrode 5n on the negative electrode first direction transferring machine 40n to the second stacker 60b and to move another negative electrode 5n on the negative electrode first direction transferring machine 40n to the negative electrode bridge 70n; and a second negative electrode supplying machine 50n2 configured to supply the negative electrode 5n on the negative electrode bridge 70n to the first stacker 60a.

The first positive electrode supplying machine 50p1 and the second positive electrode supplying machine 50p2 may be disposed side by side along the second direction D2 perpendicular to the first direction D1. The first positive electrode supplying machine 50p1 may supply the positive electrode 5p to the first stacker 60a, and the second positive electrode supplying machine 50p2 may supply the positive electrode 5p to the second stacker 60b. The first negative electrode supplying machine 50n1 and the second negative electrode supplying machine 50n2 may be disposed side by side along the second direction D2 perpendicular to the first direction D1. The first negative electrode supplying machine 50n1 may supply the negative electrode 5n to the second stacker 60b, and the second negative electrode supplying machine 50n2 may supply the negative electrode 5n to the first stacker 60a. The first positive electrode supplying machine 50p1 and the second positive electrode supplying machine 50n2 may be disposed on the positive electrode first direction transferring machine 40p. The second positive electrode supplying machine 50p2 and the first negative electrode supplying machine 50n1 may be disposed on the negative electrode first direction transferring machine 40n. In FIG. 1, it can be confirmed that the first positive electrode supplying machine 50p1 and the second positive electrode supplying machine 50p2 are disposed close to the positive electrode manufacturing machine 30p and the negative electrode manufacturing machine 30n, and that the first negative electrode supplying machine 50n1 and the second negative electrode supplying machine 50n2 are disposed far from the negative electrode manufacturing machine 30n and the positive electrode manufacturing machine 30p. Unlike FIG. 1, the first positive electrode supplying machine 50p1 and the second positive electrode supplying machine 50p2 may be disposed far from the positive electrode manufacturing machine 30p and the negative electrode manufacturing machine 30n, and the first negative electrode supplying machine 50n1 and the second negative electrode supplying machine 50n2 may be disposed close to the negative electrode manufacturing machine 30n and the positive electrode manufacturing machine 30p.

Each operation of the positive electrode manufacturing machine 30p, the positive electrode first direction transferring machine 40p, the positive electrode supplying machines 50p1 and 50p2, the first stacker 60a, the negative electrode manufacturing machine 30n, the negative electrode first direction transferring machine 40n, the negative electrode supplying machines 50n1 and 50n2, and the second stacker 60b may be organically connected to each other and may be operated as one facility.

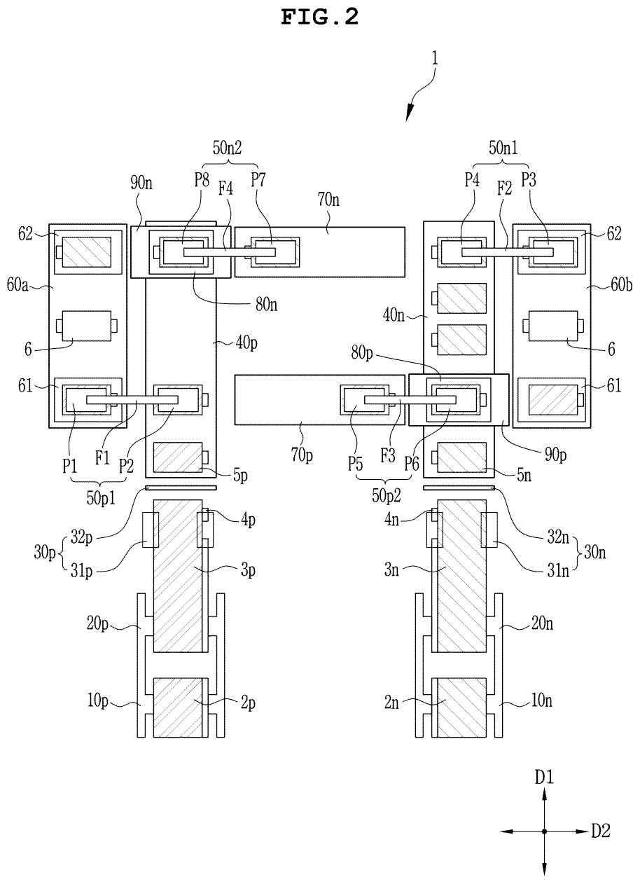

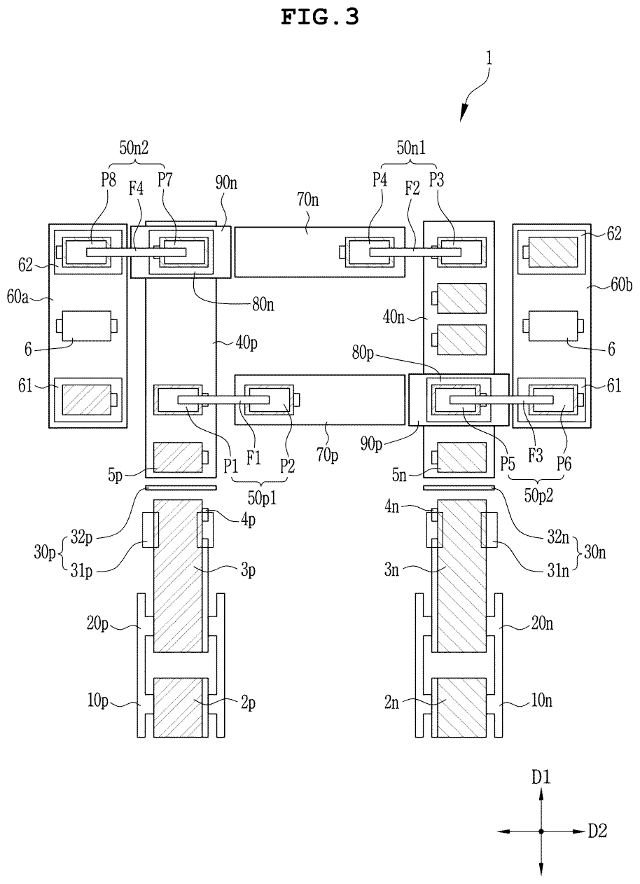

FIG. 2 is a plan view illustrating the complex facility 1 in a first motion section E1 according to an embodiment. FIG. 3 is a plan view illustrating the complex facility 1 in a second motion section E2 according to an embodiment. In FIG. 2 and FIG. 3, the first stacker 60a and the second stacker 60b are briefly illustrated. In FIG. 2 and FIG. 3, each configuration of the complex facility 1 is briefly illustrated.

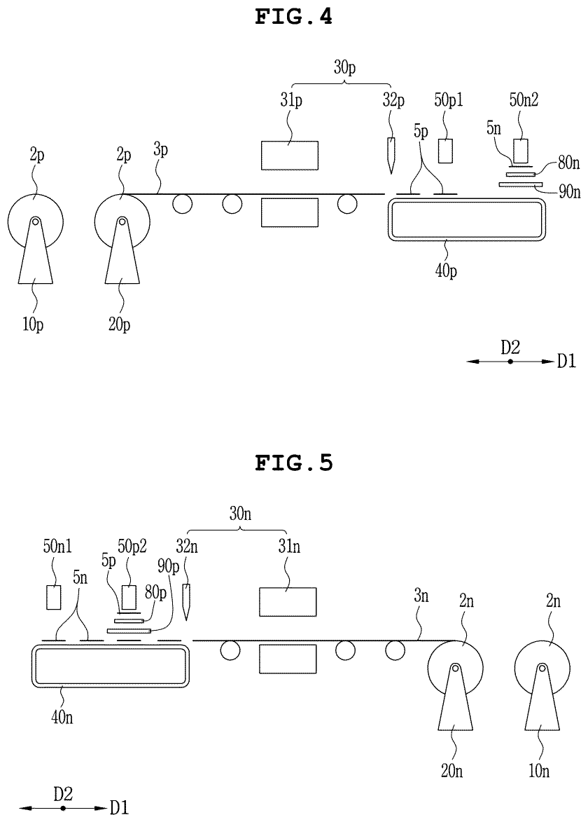

FIG. 4 is a side view of the positive electrode line of the complex facility 1 according to an embodiment. FIG. 5 is a side view illustrating the negative electrode line of the complex facility 1 according to an embodiment. FIG. 4 and FIG. 5 are illustrated on the basis of the first motion section E1. FIG. 4 is illustrated in a direction viewing the positive electrode line from the negative electrode line. FIG. 5 is illustrated in a direction viewing the negative electrode line from the positive electrode line. The present disclosure will be described with reference to FIG. 2 to FIG. 5.

The positive electrode sheet roll 2p is a roll on which the positive electrode sheet 3p is wound. The positive electrode sheet 3p may include a current collector and a positive electrode active material coated on one surface or both surfaces of the current collector. The current collector may be formed of a metal foil. The positive electrode sheet 3p may be formed by coating the current collector with the positive electrode active material and then performing a rolling process and a drying process. In a state in which the positive electrode sheet 3p is wound on a roll, the positive electrode sheet 3p may be supplied to the positive electrode unwinder 20p.

The negative electrode sheet roll 2n is a roll on which the negative electrode sheet 3n is wound. The negative electrode sheet 3n may include a current collector and a negative electrode active material coated on one surface or both surfaces of the current collector. The current collector may be formed of a metal foil. The negative electrode sheet 3n may be formed by coating the current collector with the negative electrode active material and then performing a rolling process and a drying process. In a state in which the negative electrode sheet 3n is wound on a roll, the negative electrode sheet 3n may be supplied to the negative electrode unwinder 20n.

The positive electrode unwinder 20p is an apparatus configured to unwind the positive electrode sheet roll 2p. The positive electrode unwinder 20p may unwind the positive electrode sheet roll 2p such that the positive electrode sheet 3p travels in the first direction D1. The positive electrode sheet 3p output from the positive electrode unwinder 20p may be input to the positive electrode manufacturing machine 30p. The positive electrode unwinder 20p and the positive electrode manufacturing machine 30p may be disposed side by side along the first direction D1.

The negative electrode unwinder 20n is an apparatus configured to unwind the negative electrode sheet roll 2n. The negative electrode unwinder 20n may unwind the negative electrode sheet roll 2n such that the negative electrode sheet 3n travels in the first direction D1. The negative electrode sheet 3n output from the negative electrode unwinder 20n may be input to the negative electrode manufacturing machine 30n. The negative electrode unwinder 20n and the negative electrode manufacturing machine 30n may be disposed side by side along the first direction D1.

The positive electrode unwinder 20p and the negative electrode unwinder 20n may be spaced apart from each other and disposed side by side along the second direction D2 perpendicular to the first direction D1.

The positive electrode roll changer 10 may supply the positive electrode sheet roll 2P to the positive electrode unwinder 20p. The positive electrode roll changer 10p may include a gripping apparatus, a driving part, a frame, and so on capable of transferring the positive electrode sheet roll 2p to the positive electrode unwinder 20p. When the positive electrode sheet roll 2p is depleted by the positive electrode unwinder 20p, the positive electrode roll changer 10p may withdraw an empty positive electrode sheet roll 2p in the positive electrode unwinder 20p, and may input a new positive electrode sheet roll 2p. The positive electrode roll changer 10p and the positive electrode unwinder 20p may be disposed side by side along the first direction D1.

The negative electrode roll changer 10n may supply the negative electrode sheet roll 2n to the negative electrode unwinder 20n. The negative electrode roll changer 10p may include a gripping apparatus, a driving part, a frame, and so on capable of transferring the negative electrode sheet roll 2n to the negative electrode unwinder 20n. When the negative electrode sheet roll 2n is depleted by the negative electrode unwinder 20n, the negative electrode roll changer 10n may withdraw an empty negative electrode sheet roll 2n in the negative electrode unwinder 20n, and may input a new negative electrode sheet roll 2n. The negative electrode roll changer 10n and the negative electrode unwinder 20n may be disposed side by side along the first direction D1.

The positive electrode roll changer 10p and the negative electrode roll changer 10n may be spaced apart from each other and disposed side by side along the second direction D2 perpendicular to the first direction D1.

The positive electrode manufacturing machine 30p may receive the positive electrode sheet 3p provided by the positive electrode unwinder 20p, and may manufacture the positive electrode 5p by performing a notching process and a cutting process. The positive electrode manufacturing machine 30p may include a positive electrode notching machine 31p configured to form a tab on the positive electrode sheet 3p that travels in the first direction D1, and may include a positive electrode cutter 32p configured to form the positive electrode 5p by cutting the positive electrode sheet 3p on which the tab is formed.

The positive electrode notching machine 31p may cut a portion of the current collector of the positive electrode sheet 3p, the current collector being not coated with the positive electrode active material. The remaining portion of the current collector left from the positive electrode sheet 3p may become a positive electrode tab 4p of the positive electrode 5p. The positive electrode notching machine 31p may form the positive electrode tab 4p by pressing the both surfaces of the positive electrode sheet 3p by using a mold. Alternatively, the positive electrode notching machine 31p may form the positive electrode tab 4p by cutting a portion of the positive electrode sheet 3p by using a cylindrical cutter. Alternatively, the positive electrode notching machine 31p may form the positive electrode tab 4p by using a laser cutting and so on. The electrode sheet that passes through the positive electrode notching machine 31p may travel in the first direction D1 and may be output to the positive electrode cutter 32p.

The positive electrode cutter 32p may form the positive electrode 5p by cutting the positive electrode sheet 3p at a predetermined distance, the positive electrode sheet 3p having the tab. The positive electrode cutter 32p may press and cut one surface or the both surfaces of the positive electrode sheet 3p by using a blade. Alternatively, the positive electrode cutter 32p may form the positive electrode 5p by cutting the positive electrode sheet 3p at a predetermined distance by using a cylindrical cutter. Alternatively, the positive electrode cutter 32p may form the positive electrode 5p by using a laser cutting and so on. The positive electrode 5p formed by cutting the positive electrode sheet 3p with the positive electrode cutter 32p may be output to the positive electrode first direction transferring machine 40p.

The negative electrode manufacturing machine 30n may receive the negative electrode sheet 3n provided by the negative electrode unwinder 20n, and may manufacture the negative electrode 5n by performing a notching process and a cutting process. The negative electrode manufacturing machine 30n may include a negative electrode notching machine 31n configured to form a tab on the negative electrode sheet 3n that travels in the first direction D1, and may include a negative electrode cutter 32n configured to form the negative electrode 5n by cutting the negative electrode sheet 3n on which the tab is formed.

The negative electrode notching machine 31n may cut a portion of the current collector of the negative electrode sheet 3n, the current collector being not coated with the negative electrode active material. The remaining portion of the current collector left from the negative electrode sheet 3n may become a negative electrode tab 4n of the negative electrode 5n. The negative electrode notching machine 31n may form the negative electrode tab 4n by pressing the both surfaces of the negative electrode sheet 3n by using a mold. The negative electrode notching machine 31n may form the negative electrode tab 4n by cutting a portion of the negative electrode sheet 3n by using a cylindrical cutter. Alternatively, the negative electrode notching machine 31n may form the negative electrode tab 4n by using a laser cutting and so on. The electrode sheet that passes through the negative electrode notching machine 31n may travel in the first direction D1 and may be output to the negative electrode cutter 32n.

The negative electrode cutter 32n may form the negative electrode 5n by cutting the negative electrode sheet 3n at a predetermined distance, the negative electrode sheet 3n having the tab. The negative electrode cutter 32n may press and cut one surface or the both surfaces of the negative electrode sheet 3n by using a blade. Alternatively, the negative electrode cutter 32n may form the negative electrode 5n by cutting the negative electrode sheet 3n at a predetermined distance by using a cylindrical cutter. Alternatively, the negative electrode cutter 32n may form the negative electrode 5n by using a laser cutting and so on. The negative electrode 5n formed by cutting the negative electrode sheet 3n with the negative electrode cutter 32n may be output to the negative electrode first direction transferring machine 40n.

The positive electrode first direction transferring machine 40p may transfer the positive electrode 5p along the first direction D1. The negative electrode first direction transferring machine 40n may transfer the negative electrode 5n along the first direction D1.

The first positive electrode supplying machine 50p1 may be disposed on the positive electrode first direction transferring machine 40p. The first positive electrode supplying machine 50p1 may pick up the positive electrode 5p that is transferred by the positive electrode first direction transferring machine 40p, and may provide the positive electrode 5p to the first stacker 60a. The first positive electrode supplying machine 50p1 may supply the positive electrode 5p to a positive electrode alignment table 61 of the first stacker 60a. The first positive electrode supplying machine 50p1 may pick up another positive electrode 5p that is transferred by the positive electrode first direction transferring machine 40p, and may move the positive electrode 5p to the positive electrode bridge 70p. The positive electrode 5p moved to the positive electrode bridge 70p may be supplied to the second stacker 60b by the second positive electrode supplying machine 50p2. The second positive electrode supplying machine 50p2 may supply the positive electrode 5p to the positive electrode alignment table 61 of the second stacker 60b.

The first negative electrode supplying machine 50n1 may be disposed on the negative electrode first direction transferring machine 40n. The first negative electrode supplying machine 50n1 may pick up the negative electrode 5n that is transferred by the negative electrode first direction transferring machine 40n, and may provide the negative electrode 5n to the second stacker 60b. The first negative electrode supplying machine 50n1 may supply the negative electrode 5n to a negative electrode alignment table 62 of the second stacker 60b. The first negative electrode supplying machine 50n1 may pick up another negative electrode 5n that is transferred by the negative electrode first direction transferring machine 40n, and may provide the negative electrode 5n to the negative electrode bridge 70n. The negative electrode 5n moved to the negative electrode bridge 70n may be supplied to the first stacker 60a by the second negative electrode supplying machine 50n2. The second negative electrode supplying machine 50n2 may supply the negative electrode 5n to the negative electrode alignment table 62 of the first stacker 60a.

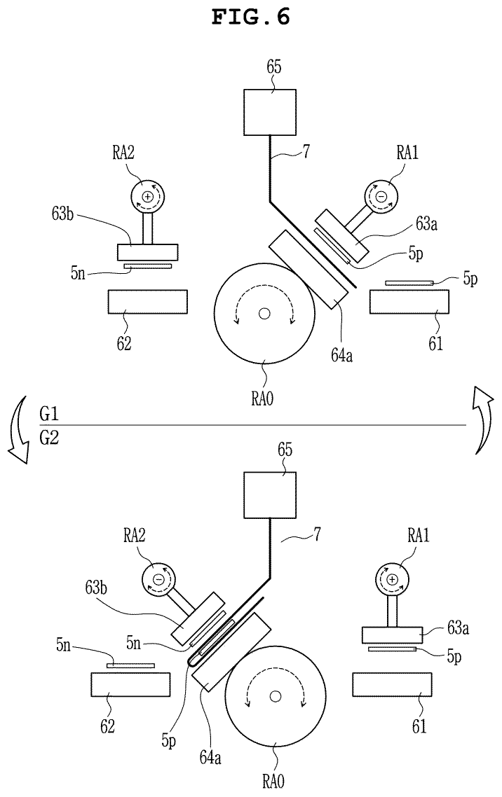

FIG. 6 is a view illustrating a rotation type stacker according to an embodiment.

Each of the first stacker 60a and the second stacker 60b may be configured as a rotation type stacker. In the rotation type stacker, a rotation stacking table 64a on which the positive electrode 5p, the separator 7, and the negative electrode 5n are stacked is configured to be rotated back and forth at a predetermined angle around a rotation axis RA0. The rotation type stacker may include: the positive electrode alignment table 61 configured to align a position of the positive electrode 5p; the negative electrode alignment table 62 configured to align a position of the negative electrode 5n; a first rotation pickup part 63a configured to pick up the positive electrode 5p on the positive electrode alignment table 61 and to move the positive electrode 5p to the rotation stacking table 64a; a second rotation pickup part 63b configured to pick up the negative electrode 5n on the negative electrode alignment table 62 and to move the negative electrode 5n to the rotation stacking table 64a; the rotation stacking table 64a configured to be rotated back and forth at the predetermined angle around the rotation axis RA0, the rotation stacking table 64a having an upper surface on which the positive electrode 5p, the separator 7, the negative electrode 5n are stacked; and a separator supplying part 65 configured to output the separator 7 on an upper surface of a stationary stacking table 64b.

The rotation axis RA0 of the rotation stacking table 64a may be positioned below the rotation stacking table 64a.

The first rotation pickup part 63a may be rotated around a rotation axis RA1 such that the first rotation pickup part 63a reciprocates to the positive electrode alignment table 61 and to the rotation stacking table 64a. The rotation axis RA1 of the first rotation pickup part 63a may be positioned above the positive electrode alignment table 61. In order to pick up and place the positive electrode 5p, a length of the first rotation pickup part 63a is capable of being adjusted toward a direction that radiates from the rotation axis RA1. The second rotation pickup part 63b may be rotated around a rotation axis RA2 such that the second rotation pickup part 63b reciprocates to the negative electrode alignment table 62 and to the rotation stacking table 64a. The rotation axis RA2 of the second rotation pickup part 63b may be positioned above the negative electrode alignment table 62. In order to pick up and place the negative electrode 5n, a length of the second rotation pickup part 63b is capable of being adjusted toward a direction that radiates from the rotation axis RA2.

In a first stacking section G1, the separator supplying part 65 may output the separator 7 toward the rotation stacking table 64a. The rotation stacking table 64a may be rotated at a predetermined angle such that the upper surface of the rotation stacking table 64a faces the first rotation pickup part 63a. When the rotation stacking table 64a is rotated, the separator 7 may cover the rotation stacking table 64a (or the negative electrode 5n). The first rotation pickup part 63a may place the positive electrode 5p on the separator 7 on the upper surface of the rotation stacking table 64a. The second rotation pickup part 63b may pick up the negative electrode 5n on the negative electrode alignment table 62. A positive electrode supplying machine may supply the positive electrode 5p to the positive electrode alignment table 61.

In a second stacking section G2, the separator supplying part 65 may output the separator 7 toward the rotation stacking table 64a. The rotation stacking table 64a may be rotated at a predetermined angle such that the upper surface of the rotation stacking table 64a faces the second rotation pickup part 63b. When the rotation stacking table 64a is rotated, the separator 7 may cover the positive electrode 5p (or the rotation stacking table 64a). The second rotation pickup part 63b may place the negative electrode 5n on the separator 7 on the upper surface of the rotation stacking table 64a. The first rotation pickup part 63a may pick up the positive electrode 5p on the positive electrode alignment table 61. A negative electrode supplying machine may supply the negative electrode 5n to the negative electrode alignment table 62.

The order of the first stacking section G1 and the second stacking section G2 may be determined so as to correspond to an operation order of the positive electrode supplying machines 50p1 and 50p2 and the negative electrode supplying machines 50n1 and 50n2.

As the rotation type stacker repeats the first stacking section G1 and the second stacking section G2, the electrode assembly 6 on which the positive electrode 5p, the separator 7, and the negative electrode 5n are stacked may be formed on the upper surface of the rotation type stacker. As the rotation type stacker repeats the first stacking section G1 and the second stacking section G2 at a set number of times, the formed electrode assembly 6 may be output. The electrode assembly 6 may be withdrawn from the rotation type stacker by an apparatus using a robot arm and a gripper.

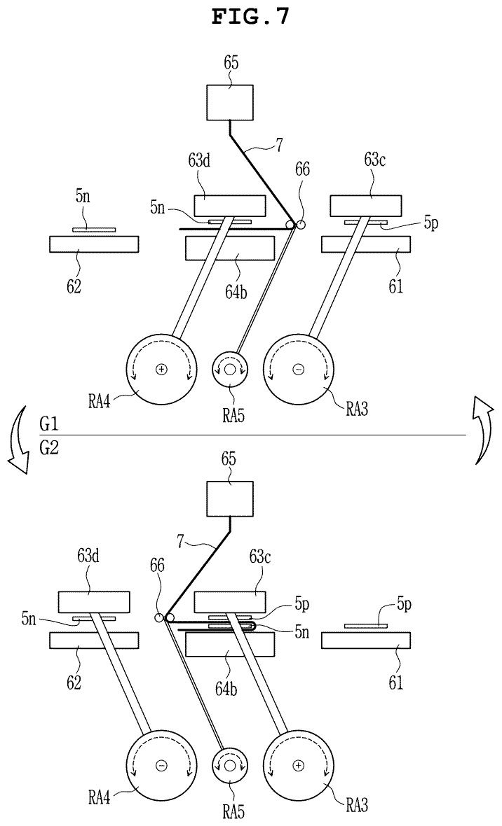

FIG. 7 is a view illustrating a stationary type stacker according to an embodiment.

Each of the first stacker 60a and the second stacker 60b may be configured as a stationary type stacker. In the stationary type stacker, the stationary stacking table 64b on which the positive electrode 5p, the separator 7, and the negative electrode 5n are stacked is not moved. The stationary type stacker may include: the positive electrode alignment table 61 configured to align a position of the positive electrode 5p; the negative electrode alignment table 62 configured to align a position of the negative electrode 5n; a third rotation pickup part 63c configured to pick up the positive electrode 5p on the positive electrode alignment table 61 and to move the positive electrode 5p to the stationary stacking table 64b; a fourth rotation pickup part 63d configured to pick up the negative electrode 5n on the negative electrode alignment table 62 and to move the negative electrode 5n to the stationary stacking table 64b; the stationary stacking table 64b having an upper surface on which the positive electrode 5p, the separator 7, and the negative electrode 5n are stacked; the separator supplying part 65 configured to output the separator 7 on the upper surface of the stationary stacking table 64b; and a separator guide part 66 configured to guide the separator 7 such that the separator 7 covers the positive electrode 5p or the negative electrode 5n.

The third rotation pickup part 63c may be rotated around a rotation axis RA3 such that the third rotation pickup part 63c reciprocates to the positive electrode alignment table 61 and to the stationary stacking table 64b. The rotation axis RA3 of the third rotation pickup part 63c may be positioned below the positive electrode alignment table 61. In order to pick up and place the positive electrode 5p, a length of the third rotation pickup part 63c is capable of being adjusted toward a direction that radiates from the rotation axis RA3. The fourth rotation pickup part 63d may be rotated around a rotation axis RA4 such that the fourth rotation pickup part 63d reciprocates to the negative electrode alignment table 62 and to the stationary stacking table 64b. The rotation axis RA4 of the fourth rotation pickup part 63d may be positioned below the negative electrode alignment table 62. In order to pick up and place the negative electrode 5n, a length of the fourth rotation pickup part 63d is capable of being adjusted toward a direction that radiates from the rotation axis RA4.

The separator guide part 66 may include a pair of rollers. The separator 7 may pass through the pair of rollers. The separator guide part 66 may rotate a position of the pair of rollers around a rotation axis RA5. The rotation axis RA5 of the separator guide part 66 may be positioned below the alignment table. The separator guide part 66 may be configured to guide the separator 7 such that the separator 7 covers the positive electrode 5p or the negative electrode 5n while the separator guide part 66 move the pair of rollers to reciprocate toward the positive electrode alignment table 61 and toward the negative electrode alignment table 62 up to a predetermined angle.

In a third stacking section, the separator guide part 66 may move the pair of rollers toward the positive electrode alignment table 61 such that the separator 7 is guided so that the separator 7 covers the stationary stacking table 64b (or the positive electrode 5p). The fourth rotation pickup part 63d may place the negative electrode 5n on the separator 7 on the upper surface of the stationary stacking table 64b. The third rotation pickup part 63c may pick up the positive electrode 5p on the positive electrode alignment table 61. The negative electrode supplying machine may supply the negative electrode 5n to the negative electrode alignment table 62.

In a fourth stacking section, the separator guide part 66 may move the pair of rollers toward the negative electrode alignment table 62 such that the separator 7 is guided so that the separator 7 covers the negative electrode 5n (or the stationary stacking table 64b). The third rotation pickup part 63c may place the positive electrode 5p on the separator 7 on the upper surface of the stationary stacking table 64b. The fourth rotation pickup part 63d may pick up the negative electrode 5n on the negative electrode alignment table 62. The positive electrode supplying machine may supply the positive electrode 5p to the positive electrode alignment table 61.

The order of the third stacking section and the fourth stacking section may be determined so as to correspond to an operation order of the positive electrode supplying machines 50p1 and 50p2 and the negative electrode supplying machines 50n1 and 50n2.

As the stationary type stacker repeats the third stacking section and the fourth stacking section, the electrode assembly 6 on which the positive electrode 5p, the separator 7, and the negative electrode 5n are stacked may be formed on the upper surface of the stationary type stacker. As the stationary type stacker repeats the third stacking section and the fourth stacking section at a set number of times, the formed electrode assembly 6 may be output. The electrode assembly 6 may be withdrawn from the stationary type stacker by an apparatus using a robot arm and a gripper.

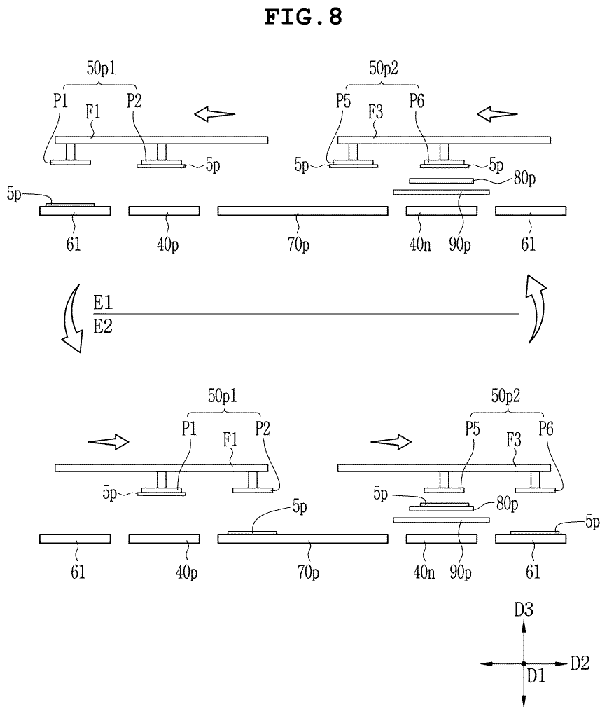

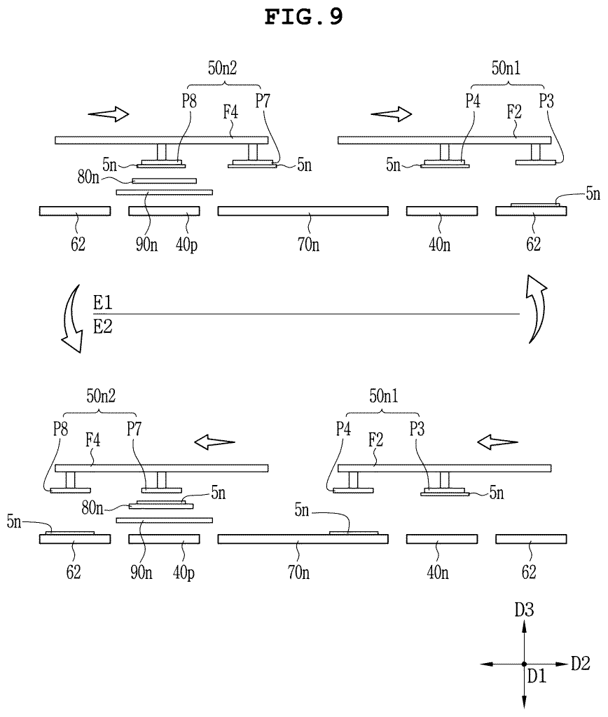

FIG. 8 is a view illustrating each operation of the first positive electrode supplying machine 50p1 and the second positive electrode supplying machine 50p2 in the first motion section E1 and the second motion section E2 according to an embodiment. In FIG. 8, the first positive electrode supplying machine 50p1 and the second positive electrode supplying machine 50p2 are illustrated in a direction viewing the positive electrode manufacturing machine 30p from the positive electrode unwinder 20p. FIG. 9 is a view illustrating each operation of the first positive electrode supplying machine 50p1 and the second positive electrode supplying machine 50p2 in the first motion section E1 and the second motion section E2 according to an embodiment. In FIG. 9, the first positive electrode supplying machine 50p1 and the second positive electrode supplying machine 50p2 are illustrated in a direction viewing the negative electrode manufacturing machine from the negative electrode unwinder 20n. The present disclosure will be described with reference to FIG. 2 and FIG. 3.

The positive electrode supplying machines 50p1 and 50p2 are apparatuses configured to pick up the positive electrode 5p transferred by the positive electrode first direction transferring machine 40p and to supply the positive electrode 5p to the stacker. The positive electrode supplying machines 50p1 and 50p2 may include the first positive electrode supplying machine 50p1 and the second positive electrode supplying machine 50p2. The negative electrode supplying machines 50n1 and 50n2 are apparatuses configured to pick up the negative electrode 5n transferred by the negative electrode first direction transferring machine 40n and to supply the negative electrode 5n to the stacker. The negative electrode supplying machines 50n1 and 50n2 may include the first negative electrode supplying machine 50n1 and the second negative electrode supplying machine 50n2.

The first positive electrode supplying machine 50p1 and the first negative electrode supplying machine 50n1 may be operated in a similar order. The first positive electrode supplying machine 50p1 may pick up the positive electrode 5p from the positive electrode first direction transferring machine 40p and may supply the positive electrode 5p directly to the first stacker 60a. The first negative electrode supplying machine 50n1 may pick up the negative electrode 5n from the negative electrode first direction transferring machine 40n and may supply the negative electrode 5n directly to the second stacker 60b.

The first positive electrode supplying machine 50p1 may include: a first pickup part P1 configured to pick up the positive electrode 5p on the positive electrode first direction transferring machine 40p and to supply the positive electrode 5p to the first stacker 60a; a second pickup part P2 configured to pick up the positive electrode 5p on the positive electrode first direction transferring machine 40p and to move the positive electrode 5p to the positive electrode bridge 70p; and a first supplying driving part F1 configured to simultaneously move the first pickup part P1 and the second pickup part P2 in the second direction D2 perpendicular to the first direction D1.

The first negative electrode supplying machine 50n1 may include: a third pickup part P3 configured to pick up the negative electrode 5n on the negative electrode first direction transferring machine 40n and to supply the negative electrode 5n to the first stacker 60a; a fourth pickup part P4 configured to pick up the negative electrode 5n on the negative electrode first direction transferring machine 40n and to move the negative electrode 5n to the negative electrode bridge 70n; and a second supplying driving part F2 configured to simultaneously move the third pickup part P3 and the fourth pickup part P4 in the second direction D2 perpendicular to the first direction D1.

The second positive electrode supplying machine 50p2 and the second negative electrode supplying machine 50n2 may be operated in a similar order. The second positive electrode supplying machine 50p2 may pick up the positive electrode that is moved to the positive electrode bridge 70p by the first positive electrode supplying machine 50p1 and may supply the positive electrode to the second stacker 60b. The second negative electrode supplying machine 50n2 may pick up the negative electrode that is moved to the negative electrode bridge 70n by the first negative electrode supplying machine 50n1 and may supply the negative electrode to the first stacker 60a.

The complex facility 1 according to an embodiment may further include: a negative electrode floating table 80n which is disposed above the positive electrode first direction transferring machine 40p such that the negative electrode floating table 80n is spaced apart from the positive electrode first direction transferring machine 40p and on which the negative electrode 5n is seated; and a positive electrode floating table 80p which is disposed above the negative electrode first direction transferring machine 40n such that the positive electrode floating table 80p is spaced apart from the negative electrode first direction transferring machine 40n and on which the positive electrode 5p is seated.

The positive electrode floating table 80p is a space in which the second positive electrode supplying machine 50p2 places the positive electrode 5p. The negative electrode floating table 80n is a space in which the second negative electrode supplying machine 50n2 places the negative electrode 5n. Since the positive electrode floating table 80p is disposed above the negative electrode first direction transferring machine 40n such that the positive electrode floating table 80p is spaced apart from the negative electrode first direction transferring machine 40n, the positive electrode floating table 80p does not interfere with the negative electrode first direction transferring machine 40n from transferring the negative electrode 5n. Since the negative electrode floating table 80n is disposed above the positive electrode first direction transferring machine 40p such that the negative electrode floating table 80n is spaced apart from the positive electrode first direction transferring machine 40p, the negative electrode floating table 80n does not interfere with the positive electrode first direction transferring machine 40p from transferring the positive electrode 5p.

The second positive electrode supplying machine 50p2 may include: a fifth pickup part P5 configured to pick up the positive electrode 5p on the positive electrode bridge 70p and to supply the positive electrode 5p to the positive electrode floating table 80p; a sixth pickup part P6 configured to pick up the positive electrode 5p on the positive electrode floating table 80p and to move the positive electrode 5p to the second stacker 60b; and a third supplying driving part F3 configured to simultaneously move the fifth pickup part P5 and the sixth pickup part P6 in the second direction D2 perpendicular to the first direction D1.

The second negative electrode supplying machine 50n2 may include: a seventh pickup part P7 configured to pick up the negative electrode 5n on the negative electrode bridge 70n and to supply the negative electrode 5n to the negative electrode floating table 80n; an eighth pickup part P8 configured to pick up the negative electrode 5n on the negative electrode floating table 80n and to move the negative electrode 5n to the first stacker 60a; and a fourth supplying driving part F4 configured to simultaneously move the seventh pickup part P7 and the eighth pickup part P8 in the second direction D2 perpendicular to the first direction D1.

Each of the first positive electrode supplying machine 50p1, the first negative electrode supplying machine 50n1, the second positive electrode supplying machine 50p2, and the second negative electrode supplying machine 50n2 may equally include two pickup parts and one supplying driving part. The supplying driving part may simultaneously move two pickup parts in the second direction D2. The supplying driving part may move the two pickup parts to be reciprocated in the second direction D2. When the two pickup parts are moved to a first side or a second side in the second direction D2 by the supplying driving part, a pickup operation or a pickup releasing operation may be performed. In the two pickup parts, one of the two pickup parts may perform the pickup operation, and the other pickup part may perform the pickup releasing operation. Alternatively, the two pickup parts may simultaneously perform the pickup operation, or may simultaneously perform the pickup releasing operation. The four supplying machines have the same structure in which two pickup parts and one supplying driving part are included. Therefore, it is convenient to control the plurality of supplying machines simultaneously, and it is convenient to maintain the plurality of supplying machines. In order to use the supplying machines having the same structure, the positive electrode floating table 80p and the negative electrode floating table 80n may be mounted respectively on transferring machines having different polarity.

The pickup operation is an operation in which an electrode on a table or a transferring machine is lifted. The pickup releasing operation is an operation in which the electrode lifted by the pickup part is placed on a predetermined position. The pickup part may pick up or place the electrode by using such as a vacuum adsorption manner, a gripper, an electromagnetic force, an adhesive force, and so on. In order to pick up the electrode, a length of the pickup part may be adjusted in a third direction D3 perpendicular to the first direction D1 and the second direction D2. The second positive electrode supplying machine 50p2 and the second negative electrode supplying machine 50n2 may perform a length adjustment of the pickup part in order to pick up the electrode on the floating table. An operation in which the supplying driving part reciprocates the pickup part in the second direction D2 and the length adjustment operation of the pickup part may be performed in various manners using such as a slider, a motor, a gear, a robot arm, and so on.

The complex facility 1 may further include: a negative electrode partition 90n which is positioned between the positive electrode first direction transferring machine 40p and the negative electrode floating table 80n and which extends along a path where the second negative electrode supplying machine 50n2 moves the negative electrode 5n, the negative electrode partition 90n being configured to prevent negative electrode particles dropping from the negative electrode 5n from dropping on the positive electrode first direction transferring machine 40p; and a positive electrode partition 90p which is positioned between the negative electrode first direction transferring machine 40n and the positive electrode floating table 80p and which extends along a path where the second positive electrode supplying machine 50p2 moves the positive electrode 5p, the positive electrode partition 90p being configured to prevent positive electrode particles dropping from the positive electrode 5p from dropping on the negative electrode first direction transferring machine 40n.

The negative electrode partition 90n may prevent foreign substances such as a negative electrode active material and so on falling from the negative electrode 5n from being introduced into the positive electrode first direction transferring machine 40p, the foreign substances falling during a process in which the negative electrode 5n is moved above the positive electrode first direction transferring machine 40p. The negative electrode partition 90n is positioned between a path in which the positive electrode 5p is transferred and a path in which the negative electrode 5n is transferred, and may partition a space.

The negative electrode partition 90n may be formed in a plate shape. The negative electrode partition 90n may be formed such that a width of the negative electrode partition 90n is wider than a width of the negative electrode floating table 80n. The negative electrode partition 90n may be formed along a path in which the second negative electrode supplying machine 50n2 is moved. The negative electrode partition 90n may be positioned between the positive electrode first direction transferring machine 40p and the negative electrode floating table 80n. The negative electrode partition 90n may be sufficiently spaced apart from the positive electrode first direction transferring machine 40p so that the positive electrode 5p is not obstructed from being moved on the positive electrode first direction transferring machine 40p.

In a process in which the second negative electrode supplying machine 50n2 picks up and moves the negative electrode 5n, a portion of an adhesive layer of the negative electrode 5n may be separated and fall. When the portion of the falling adhesive layer is in contact with the positive electrode 5p or is mixed with the positive electrode 5p by contacting the positive electrode first direction transferring machine 40p, a function of the electrode assembly 6 may be reduced. The negative electrode partition 90n may prevent foreign substances that may be formed during a process in which the second negative electrode supplying machine 50n2 picks up and moves the negative electrode 5n from being in contact with the positive electrode 5p.

The positive electrode partition 90p may prevent foreign substances such as a positive electrode active material and so on falling from the positive electrode 5p from being introduced into the negative electrode first direction transferring machine 40n, the foreign substances falling during a process in which the positive electrode 5p is moved above the negative electrode first direction transferring machine 40n. The positive electrode partition 90p is positioned between a path in which the positive electrode 5p is transferred and a path in which the negative electrode 5n is transferred, and may partition a space.

The positive electrode partition 90p may be formed in a plate shape. The positive electrode partition 90p may be formed such that a width of the positive electrode partition 90p is wider than a width of the positive electrode floating table 80p. The positive electrode partition 90p may be formed along a path in which the second positive electrode supplying machine 50p2 is moved. The positive electrode partition 90p may be positioned between the negative electrode first direction transferring machine 40n and the positive electrode floating table 80p. The positive electrode partition 90p may be sufficiently spaced apart from the negative electrode first direction transferring machine 40n so that the negative electrode 5n is not obstructed from being moved on the negative electrode first direction transferring machine 40n.

In a process in which the second positive electrode supplying machine 50p2 picks up and moves the positive electrode 5p, a portion of an adhesive layer of the positive electrode 5p may be separated and fall. When the portion of the falling adhesive layer is in contact with the negative electrode 5n or is mixed with the negative electrode 5n by contacting the negative electrode first direction transferring machine 40n, a function of the electrode assembly 6 may be reduced. The positive electrode partition 90p may prevent foreign substances that may be formed during a process in which the second positive electrode supplying machine 50p2 picks up and moves the positive electrode 5p from being in contact with the negative electrode 5n.

The positive electrode bridge 70p may move the positive electrode 5p that is moved by the first positive electrode supplying machine 50p1 to a position where the second positive electrode supplying machine 50p2 picks up the positive electrode 5p, and the negative electrode bridge 70n may move the negative electrode 5n that is moved by the first negative electrode supplying machine 50n1 to a position where the second negative electrode supplying machine 50n2 picks up the negative electrode 5n.

The positive electrode bridge 70p and the negative electrode bridge 70n may be implemented in various manners, such as a conveyor belt, an LMS, a plate mechanically reciprocating or rotating, and so on. The positive electrode bridge 70p may move the positive electrode 5p that is placed on a first side of the positive electrode bridge 70p by the first positive electrode supplying machine 50p1 to a second side of the positive electrode bridge 70p. The second positive electrode supplying machine 50p2 may pick up the positive electrode 5p that is moved to the second side of the positive electrode bridge 70p. The negative electrode bridge 70n may move the negative electrode 5n that is placed on a first side of the negative electrode bridge 70n by the first negative electrode supplying machine 50n1 to a second side of the negative electrode bridge 70n. The second negative electrode supplying machine 50n2 may pick up the negative electrode 5n that is moved to the second side of the negative electrode bridge 70n. The positive electrode bridge 70p may move the positive electrode 5p toward the negative electrode first direction transferring machine 40n, and the negative electrode bridge 70n may move the negative electrode 5n toward the positive electrode first direction transferring machine 40p. That is, the positive bridge 70p and the negative bridge 70n may move the positive electrode 5p or the negative electrode 5n in the second direction D2.

The first positive electrode supplying machine 50p1, the second positive electrode supplying machine 50p2, the first negative electrode supplying machine 50n1, and the second negative electrode supplying machine 50n2 may supply the electrode to the stacker by repeating the operation performed in the first motion section E1 and the operation performed in the second motion section E2.

The first positive electrode supplying machine 50p1, the positive electrode bridge 70p, and the second positive electrode supplying machine 50p2 may be disposed on the same line in the second direction D2, and the first negative electrode supplying machine 50n1, the negative electrode bridge 70n, and the second negative electrode supplying machine 50n2 may be disposed on the same line in the second direction D2. The positive electrode 5p that is transferred by the positive electrode first direction transferring machine 40p may be supplied to the second stacker 60b through the negative electrode first direction transferring machine 40n by passing through the first positive electrode supplying machine 50p1, the positive electrode bridge 70p, and the second positive electrode supplying machine 50p2. The negative electrode 5n that is transferred by the negative electrode first direction transferring machine 40n may be supplied to the first stacker 60a through the positive electrode first direction transferring machine 40p by passing through the first negative electrode supplying machine 50n1, the negative electrode bridge 70n, and the second negative electrode supplying machine 50n2.

A plurality of first stackers 60a and a plurality of second stackers 60b may be disposed. In FIG. 1, FIG. 2, and FIG. 3, one first stacker 60a, one second stacker 60b, one positive electrode second direction transferring machine 50p, and one negative electrode second direction transferring machine 50n are disposed. Here, at least one more first stacker 60a and the second stacker 60b may be disposed in the first direction D1. That is, at least two first stackers 60a may be disposed, and at least two second stackers 60b may be disposed. In order to supply the positive electrode 5p and the negative electrode 5n to the first stacker 60a and the second stacker 60b that are additionally disposed, the positive electrode second direction transferring machine 50p and the negative electrode second direction transferring machine 50n may be further disposed.

Only one of the first stacker 60a and the second stacker 60b may be further disposed. In this situation, in order to supply the positive electrode 5p and the negative electrode 5n to the first stacker 60a or the second stacker 60b that is additionally disposed, the positive electrode second direction transferring machine 50p and the negative electrode second direction transferring machine 50n may be further disposed.

At least one first stacker 60a and at least one second stacker 60b may be disposed as a pair, and at least one positive electrode second direction transferring machine 50p and the negative electrode second direction transferring machine 50n may be disposed as a pair.

The pair of positive electrode second direction transferring machine 50p and negative electrode second direction transferring machine 50n may supply the positive electrode 5p and the negative electrode 5n to the pair of first stacker 60a and second stacker 60b. In a similar structure, at least two pairs of first stackers 60a and second stackers 60b and at least two pairs of positive electrode second direction transferring machines 50p and negative electrode second direction transferring machines 50n may be disposed on the positive electrode first direction transferring machine 40p and the negative electrode first direction transferring machine 40n. The first pair of first stacker 60a and second stacker 60b and the second pair of first stacker 60a and second stacker 60b may be disposed sequentially in the first direction D1 along the positive electrode first direction transferring machine 40p and the negative electrode first direction transferring machine 40n. The first pair of positive electrode second direction transferring machine 50p and negative electrode second direction transferring machine 50n and the second pair of positive electrode second direction transferring machine 50p and negative electrode second direction transferring machine 50n may be disposed sequentially in the first direction D1 along the positive electrode first direction transferring machine 40p and the negative electrode first direction transferring machine 40n.

The first positive electrode supplying machine 50p1 may be configured such that the first pickup part P1 and the second pickup part P2 are reciprocated in the second direction D2 by the first supplying driving part F1 so that each operation determined in the first motion section E1 and the second motion section E2 is repeated, and the first negative electrode supplying machine 50n1 may be configured such that the third pickup part P3 and the fourth pickup part P4 are reciprocated in the second direction D2 by the second supplying driving part F2 so that each operation determined in the first motion section E1 and the second motion section E2 is repeated.

In the first motion section E1, when the first pickup part P1 of the first positive electrode supplying machine 50p1 picks up the positive electrode 5p on the positive electrode first direction transferring machine 40p, the second pickup part P2 may place the positive electrode 5p on the first stacker 60a at the same time. Furthermore, when the third pickup part P3 of the first negative electrode supplying machine 50n1 picks up the negative electrode 5n on the negative electrode first direction transferring machine 40n, the fourth pickup part P4 may place the negative electrode 5n on the second stacker 60b at the same time. In the second motion section E2, when the first pickup part P1 of the first positive electrode supplying machine 50p1 places the positive electrode 5p on the positive electrode bridge 70p, the second pickup part P2 may pick up the positive electrode 5p on the positive electrode first direction transferring machine 40p at the same time. Furthermore, when the third pickup part P3 of the first negative electrode supplying machine 50n1 places the negative electrode 5n on the negative electrode bridge 70n, the fourth pickup part P4 may pick up the negative electrode 5n on the negative electrode first direction transferring machine 40n at the same time.

The second positive electrode supplying machine 50p2 may be configured such that the fifth pickup part P5 and the sixth pickup part P6 are reciprocated in the second direction D2 by the third supplying driving part F3 so that each operation determined in the first motion section E1 and the second motion section E2 is repeated, and the second negative electrode supplying machine 50n2 may be configured such that the seventh pickup part P7 and the eighth pickup part P8 are reciprocated in the second direction D2 by the fourth supplying driving part F4 so that each operation determined in the first motion section E1 and the second motion section E2 is repeated.

In the first motion section E1, when the fifth pickup part P5 of the second positive electrode supplying machine 50p2 picks up the positive electrode 5p on the positive electrode bridge 70p, the sixth pickup part P6 may pick up the positive electrode 5p on the positive electrode floating table 80p at the same time. Furthermore, when the seventh pickup part P7 of the second negative electrode supplying machine 50n2 picks up the negative electrode 5n on the negative electrode bridge 70n, the eighth pickup part P8 may pick up the electrode on the negative electrode floating table 80n at the same time. In the second motion section E2, when the fifth pickup part P5 of the second positive electrode supplying machine 50p2 places the positive electrode 5p on the positive electrode floating table 80p, the sixth pickup part P6 may place the positive electrode 5p on the second stacker 60b at the same time. Furthermore, when the seventh pickup part P7 of the second negative electrode supplying machine 50n2 places the negative electrode 5n on the negative electrode floating table 80n, the eighth pickup part P8 may place the negative electrode 5n on the first stacker 60a at the same time.

The present disclosure will be described with reference to FIG. 2, FIG. 3, and FIG. 8. In the first motion section E1, the first supplying driving part F1 may move the second pickup part P2 to the positive electrode first direction transferring machine 40p, and may move the first pickup part P1 to the positive electrode alignment table 61 of the first stacker 60a. The second pickup part P2 may pick up the positive electrode 5p on the positive electrode first direction transferring machine 40p. The first pickup part P1 may place the positive electrode 5p on the positive electrode alignment table 61 of the first stacker 60a. At the same time, in the first motion section E1, the second supplying driving part F2 may move the fifth pickup part P5 on the positive electrode bridge 70p, and may move the sixth pickup part P6 on the positive electrode floating table 80p. The fifth pickup part P5 may pick up the positive electrode 5p on the positive electrode bridge 70p. The sixth pickup part P6 may pick up the positive electrode 5p on the positive electrode floating table 80p.

In the second motion section E2, the first supplying driving part F1 may move the second pickup part P2 to the positive electrode bridge 70p, and may move the first pickup part P1 to the positive electrode first direction transferring machine 40p. The second pickup part P2 may place the positive electrode 5p on the positive electrode bridge 70p. The first pickup part P1 may pick up the positive electrode 5p on the positive electrode first direction transferring machine 40p. At the same time, in the second motion section E2, the second supplying driving part F2 may move the fifth pickup part P5 to the positive electrode floating table 80p, and may move the sixth pickup part P6 to the positive electrode alignment table 61 of the second stacker 60b. The fifth pickup part P5 may place the positive electrode 5p on the positive electrode floating table 80p. The sixth pickup part P6 may place the positive electrode 5p on the positive electrode alignment table 61 of the second stacker 60b.

The present disclosure will be described with reference to FIG. 2, FIG. 3, and FIG. 9. In the first motion section E1, the second supplying driving part F2 may move the fourth pickup part P4 to the negative electrode first direction transferring machine 40n, and may move the third pickup part P3 to the negative electrode alignment table 62 of the second stacker 60b. The fourth pickup part P4 may pick up the negative electrode 5n on the negative electrode first direction transferring machine 40n. The third pickup part P3 may place the negative electrode 5n on the negative electrode alignment table 62 of the second stacker 60b. At the same time, in the first motion section E1, the fourth supplying driving part F4 may move the seventh pickup part P7 on the negative electrode bridge 70n, and may move the eighth pickup part P8 on the negative electrode floating table 80n. The seventh pickup part P7 may pick up the negative electrode 5n on the negative electrode bridge 70n. The eighth pickup part P8 may pick up the negative electrode 5n on the negative electrode floating table 80n.

In the second motion section E2, the second supplying driving part F2 may move the fourth pickup part P4 to the negative electrode bridge 70n, and may move the third pickup part P3 to the negative electrode first direction transferring machine 40n. The fourth pickup part P4 may place the negative electrode 5n on the negative electrode bridge 70n. The third pickup part P3 may pick up the negative electrode 5n on the negative electrode first direction transferring machine 40n. At the same time, in the second motion section E2, the fourth supplying driving part F4 may move the seventh pickup part P7 to the negative electrode floating table 80n, and may move the eighth pickup part P8 to the negative electrode alignment table 62 of the first stacker 60a. The seventh pickup part P7 may place the negative electrode 5n on the negative electrode floating table 80n. The eighth pickup part P8 may place the negative electrode 5n on the negative electrode alignment table 62 of the first stacker 60a.

A speed at which the positive electrode first direction transferring machine 40p and the negative electrode first direction transferring machine 40n transfer the positive electrode 5p and the negative electrode 5n may be determined according to the cycle in which the first motion section E1 and the second motion section E2 are repeated.

When each operation of the supplying machines is repeated in the first motion section E1 and the second motion section E2, the positive electrode 5p and the negative electrode 5n may be supplied to each stacker. Each stacker may repeat the order of the first stacking section G1 and the second stacking section G2 so as to correspond to the first motion section E1 and the second motion section E2, thereby being capable of manufacturing the electrode assembly 6.

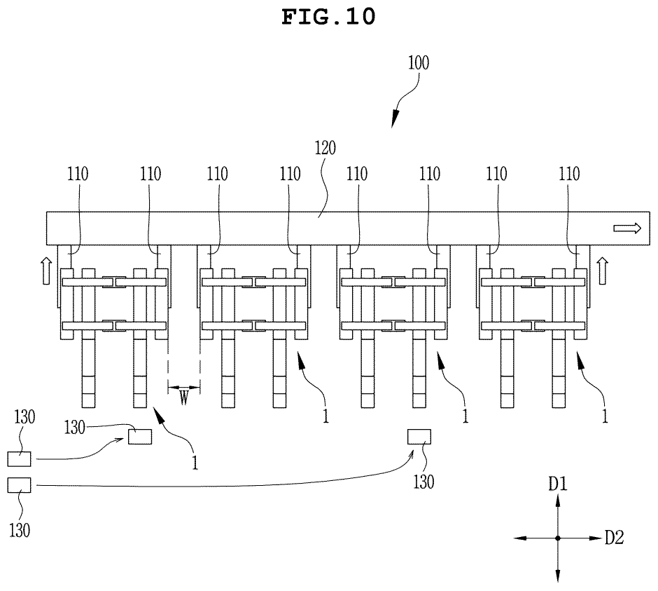

FIG. 10 is a view illustrating a facility layout 100 according to an embodiment.

The facility layout 100 according to an embodiment is a structure in which apparatuses such as the unwinders 20p and 20n, the roll changers 10p and 10n, the notching machines 31p and 31n, the cutters 32p and 32n, the first direction transferring machines 40p and 40n, the second direction transferring machines 50p and 50n, the stackers 60a and 60b, and so on disposed in a secondary battery manufacturing factory are disposed.

The facility layout 100 according to an embodiment may include: the plurality of complex facilities 1 described with reference to FIG. 1 to FIG. 9; a plurality of first carriers 110 configured to transfer the electrode assembly 6 manufactured by the first stacker 60a and the second stacker 60b of the complex facility 1 in the first direction D1; and a second carrier 120 configured to receive the electrode assembly 6 transferred by the plurality of first carriers 110 and to transfer the electrode assembly 6 in the second direction D2.

The complex facility 1 is an apparatus in which various apparatuses (for example, the roll changers 10p and 10n, the unwinders 20p and 20n, the notching machines 31p and 31n, the cutters 32p and 32n, the first direction transferring machines 40p and 40n, the second direction transferring machines 50p and 50n, and the stackers 60a and 60b) required for manufacturing the electrode assembly 6 are disposed so that the various apparatuses are capable of being operated in a single flow. The complex facility 1 is designed such that the plurality of various apparatuses occupies a minimum area.

The first carrier 110 may transfer the electrode assembly 6 manufactured by the complex facility 1. The second carrier 120 may transfer the electrode assembly 6 received from the first carrier 110. The first carrier 110 and the second carrier 120 may be implemented as a conveyor belt, an LMS, and various other transferring apparatuses. The first carrier 110 may be disposed in the first direction D1. The first carrier 110 may be disposed such that one first carrier 110 is disposed in the first stacker 60a and one first carrier 110 is disposed in the second stacker 60b. That is, two first carriers 110 may be disposed in one complex facility 1. The first carrier 110 may receive the electrode assembly 6 manufactured in the stacker of the complex facility 1 and may transfer the electrode assembly 6 to the second carrier 120. The second carrier 120 may receive the electrode assembly 6 from the plurality of first carriers 110 and may transfer the electrode assembly 6. The second carrier 120 may be disposed in the second direction D2.

The plurality of complex facilities 1 may be disposed such that the plurality of first carriers 110 is connected to the second carrier 120. In the plurality of complex facilities 1, the stackers 60a and 60b may be positioned close to the second carrier 120, and the unwinder may be disposed far from the second carrier 120. The plurality of notching and stacking facilities may be disposed to be spaced apart from each other by a predetermined distance W. That is, the plurality of complex facilities 1 may be disposed as a comb that extends to one side from the second carrier 120. Furthermore, the plurality of complex facilities 1 may be disposed as a comb that extends to both sides around the second carrier 120. In this situation, the manufactured electrode assembly 6 may be output from the both sides toward the second carrier 120.

The plurality of complex facilities 1 may be disposed to be spaced apart from each other in the second direction D2. The plurality of complex facilities 1 may be disposed to be spaced apart from each other by the predetermined distance W along the second carrier 120 that extends in the second direction D2. The distance W between the plurality of complex facilities 1 may be determined as a distance sufficient for the worker to enter between the stackers and to perform a work. The worker may enter the space between the plurality of complex facilities 1. The worker may enter along the first direction D1 and may access the roll changers 10p and 10n, the unwinders 20p and 20n, the notching machines 31p and 31n, the cutters 32p and 32n, the first direction transferring machines 40p and 40n, the second direction transferring machines 50p and 50n, the stackers 60a and 60b, and the first carriers 110. Since the plurality of apparatuses in the complex facility 1 is disposed in the first direction D1, the worker may enter along the first direction D1 and may access the plurality of apparatuses. In the manufacturing process of the electrode assembly 6, all materials or the worker may be moved in the first direction D1, and the electrode assembly 6 is moved in the second direction D2, so that the flow of the factory may be simplified.

The facility layout 100 according to an embodiment may further include a roll transferring unit 130 configured to transfer the positive electrode sheet roll 2p or the negative electrode sheet roll 2n to the plurality of complex facilities 1 and to be autonomously driven. The roll transferring unit 130 may supply a roll to the positive electrode roll changer 10p or the negative electrode roll changer 10n while being moved in a state in which the positive electrode sheet roll 2p or the negative electrode sheet roll 2n is loaded in the roll transferring unit 130. In the facility layout 100, since the roll changers of the plurality of complex facilities 1 are positioned side by side, a flow line in which the roll transferring unit 130 accesses the roll changers may be simplified. Since a time is required for the complex facility 1 to deplete the roll, one roll transferring unit 130 may supply the roll to the plurality of complex facilities 1. In addition, since flow line in which the roll transferring unit 130 reaches the plurality of complex facilities 1 is simple, the movement time may be minimized. Therefore, in the facility layout 100 according to an embodiment, the number of roll transferring units 130 may be relatively small compared to the number of the complex facilities 1. Therefore, the space occupied by the roll transferring unit 130 and the space required for the roll transferring unit 130 to be moved inside the factory may be minimized.

The present disclosure has been described in detail through specific embodiments. The contents described above are only examples of applying the principles of the present disclosure, and other configurations may be further included within the scope of the present disclosure.

What is claimed is:

1. A complex facility comprising:
a positive electrode manufacturing machine configured to form a positive electrode by forming and cutting a tab on a positive electrode sheet that travels in a first direction;
a negative electrode manufacturing machine configured to form a negative electrode by forming and cutting a tab on a negative electrode sheet that travels in the first direction, the negative electrode manufacturing machine being disposed parallel to the positive electrode manufacturing machine;
a positive electrode first direction transferring machine configured to transfer the positive electrode in the first direction, the positive electrode being output from the positive electrode manufacturing machine;
a negative electrode first direction transferring machine configured to transfer the negative electrode in the first direction, the negative electrode being output from the negative electrode manufacturing machine;
at least one first stacker positioned on an opposite side of the negative electrode first direction transferring machine with respect to the positive electrode first direction transferring machine and configured to form an electrode assembly by stacking the positive electrode, a separator, and the negative electrode;
at least one second stacker positioned on an opposite side of the positive electrode first direction transferring machine with respect to the negative electrode first direction transferring machine and configured to form the electrode assembly by stacking the positive electrode, the separator, and the negative electrode;
at least one positive electrode second direction transferring machine configured to transfer the positive electrode transferred from the positive electrode first direction transferring machine in a second direction and to supply the positive electrode to the first stacker and the second stacker, and
at least one negative electrode second direction transferring machine configured to transfer the negative electrode transferred from the negative electrode first direction transferring machine in the second direction and to supply the negative electrode to the first stacker and the second stacker.

2. The complex facility of claim 1, wherein the positive electrode manufacturing machine comprises:
a positive electrode notching machine configured to form the tab on the positive electrode sheet that travels in the first direction; and
a positive electrode cutter configured to form the positive electrode by cutting the positive electrode sheet on which the tab is formed, and
wherein the negative electrode manufacturing machine comprises:
a negative electrode notching machine configured to form the tab on the negative electrode sheet that travels in the first direction; and
a negative electrode cutter configured to form the negative electrode by cutting the negative electrode sheet on which the tab is formed.

3. The complex facility of claim 1, further comprising:
a positive electrode unwinder configured to supply the positive electrode sheet to the positive electrode manufacturing machine by unwinding a positive electrode sheet roll in the first direction; and
a negative electrode unwinder configured to supply the negative electrode sheet to the negative electrode manufacturing machine by unwinding a negative electrode sheet roll in the first direction.

4. The complex facility of claim 3, further comprising:
a positive electrode roll changer configured to discharge a depleted positive electrode sheet roll and to replace the depleted positive electrode sheet roll with a new positive electrode sheet roll when the positive electrode sheet roll in the positive electrode unwinder is depleted; and
a negative electrode roll changer configured to discharge a depleted negative electrode sheet roll and to replace the depleted negative electrode sheet roll with a new negative electrode sheet roll when the negative electrode sheet roll in the negative electrode unwinder is depleted.

5. The complex facility of claim 1, wherein the positive electrode second direction transferring machine comprises:
a positive electrode bridge which is positioned between the positive electrode first direction transferring machine and the negative electrode first direction transferring machine and on which the positive electrode is seated;
a first positive electrode supplying machine configured to supply the positive electrode on the positive electrode first direction transferring machine to the first stacker and to move another positive electrode on the positive electrode first direction transferring machine to the positive electrode bridge; and
a second positive electrode supplying machine configured to supply the positive electrode on the positive electrode bridge to the second stacker, and
wherein the negative electrode second direction transferring machine comprises:
a negative electrode bridge which is positioned between the positive electrode first direction transferring machine and the negative electrode first direction transferring machine and on which the negative electrode is seated;
a first negative electrode supplying machine configured to supply the negative electrode on the negative electrode first direction transferring machine to the second stacker and to move another negative electrode on the negative electrode first direction transferring machine to the negative electrode bridge; and
a second negative electrode supplying machine configured to supply the negative electrode on the negative electrode bridge to the first stacker.

6. The complex facility of claim 5, wherein the first positive electrode supplying machine comprises:
a first pickup part configured to pick up the positive electrode on the positive electrode first direction transferring machine and to supply the positive electrode to the first stacker,
a second pickup part configured to pick up the positive electrode on the positive electrode first direction transferring machine and to supply the positive electrode to the positive electrode bridge; and
a first supplying driving part configured to simultaneously move the first pickup part and the second pickup part in the second direction perpendicular to the first direction, and
wherein the first negative electrode supplying machine comprises:
a third pickup part configured to pick up the negative electrode on the negative electrode first direction transferring machine and to supply the negative electrode to the first stacker;
a fourth pickup part configured to pick up the negative electrode on the negative electrode first direction transferring machine and to supply the negative electrode to the negative electrode bridge; and
a second supplying driving part configured to simultaneously move the third pickup part and the fourth pickup part in the second direction perpendicular to the first direction.

7. The complex facility of claim 5, further comprising:
a negative electrode floating table which is spaced apart from above the positive electrode first direction transferring machine and on which the negative electrode is seated; and
a positive electrode floating table which is spaced apart from above the negative electrode first direction transferring machine and on which the positive electrode is seated,
wherein the second positive electrode supplying machine comprises:
a fifth pickup part configured to pick up the positive electrode on the positive electrode bridge and to move the positive electrode to the positive electrode floating table;
a sixth pickup part configured to pick up the positive electrode on the positive electrode floating table and to supply the positive electrode to the second stacker; and
a third supplying driving part configured to simultaneously move the fifth pickup part and the sixth pickup part in the second direction perpendicular to the first direction, and
wherein the second negative electrode supplying machine comprises:
a seventh pickup part configured to pick up the negative electrode on the negative electrode bridge and to move the negative electrode to the negative electrode floating table;
an eighth pickup part configured to pick up the negative electrode on the negative electrode floating table and to supply the negative electrode to the first stacker; and
a fourth supplying driving part configured to simultaneously move the seventh pickup part and the eighth pickup part in the second direction perpendicular to the first direction.

8. The complex facility of claim 7, further comprising:
a negative electrode partition which is positioned between the positive electrode first direction transferring machine and the negative electrode floating table and which extends along a path where the second negative electrode supplying machine moves the negative electrode, the negative electrode partition being configured to prevent negative electrode particles dropping from the negative electrode from dropping on the positive electrode first direction transferring machine; and
a positive electrode partition which is positioned between the negative electrode first direction transferring machine and the positive electrode floating table and which extends along a path where the second positive electrode supplying machine moves the positive electrode, the positive electrode partition being configured to prevent positive electrode particles dropping from the positive electrode from dropping on the negative electrode first direction transferring machine.

9. The complex facility of claim 5, wherein the positive electrode bridge is configured to move the positive electrode moved by the first positive electrode supplying machine to a position where the second positive electrode supplying machine picks up the positive electrode, and the negative electrode bridge is configured to move the negative electrode moved by the first negative electrode supplying machine to a position where the second negative electrode supplying machine picks up the negative electrode.

10. The complex facility of claim 6, wherein the first positive electrode supplying machine is configured such that the first pickup part and the second pickup part are reciprocated in the second direction by the first supplying driving part so that each operation determined in a first motion section and a second motion section is repeated,
the first negative electrode supplying machine is configured such that the third pickup part and the fourth pickup part are reciprocated in the second direction by the second supplying driving part so that each operation determined in the first motion section and the second motion section is repeated,
in the first motion section, when the first pickup part of the first positive electrode supplying machine picks up the positive electrode on the positive electrode first direction transferring machine, the second pickup part places the positive electrode on the first stacker at the same time, and when the third pickup part of the first negative electrode supplying machine picks up the negative electrode on the negative electrode first direction transferring machine, the fourth pickup part places the negative electrode on the second stacker at the same time, and
in the second motion section, when the first pickup part of the first positive electrode supplying machine places the positive electrode on the positive electrode bridge, the second pickup part picks up the positive electrode on the positive electrode first direction transferring machine at the same time, and when the third pickup part of the first negative electrode supplying machine places the negative electrode on the negative electrode bridge, the fourth pickup part picks up the negative electrode on the negative electrode first direction transferring machine at the same time.

11. The complex facility of claim 7, wherein the second positive electrode supplying machine is configured such that the fifth pickup part and the sixth pickup part are reciprocated in the second direction by the third supplying driving part so that each operation determined in a first motion section and a second motion section is repeated,
the second negative electrode supplying machine is configured such that the seventh pickup part and the eighth pickup part are reciprocated in the second direction by the fourth supplying driving part so that each operation determined in the first motion section and the second motion section is repeated,
in the first motion section, when the fifth pickup part of the second positive electrode supplying machine picks up the positive electrode on the positive electrode bridge, the sixth pickup part picks up the positive electrode on the positive electrode floating table at the same time, and when the seventh pickup part of the second negative electrode supplying machine picks up the negative electrode on the negative electrode bridge, the eighth pickup part picks up the negative electrode on the negative electrode floating table at the same time, and
in the second motion section, when the fifth pickup part of the second positive electrode supplying machine places the positive electrode on the positive electrode floating table, the sixth pickup part places the positive electrode on the second stacker at the same time, and when the seventh pickup part of the second negative electrode supplying machine places the negative electrode on the negative electrode floating table, the eighth pickup part places the negative electrode on the first stacker at the same time.

12. The complex facility of claim 5, wherein the first positive electrode supplying machine, the positive electrode bridge, and the second positive electrode supplying machine are disposed on a same line in the second direction, and the first negative electrode supplying machine, the negative electrode bridge, and the second negative electrode supplying machine are disposed on a same line in the second direction.

13. A facility layout comprising:
a plurality of complex facilities according to claim 1;
a plurality of first carriers configured to transfer an electrode assembly manufactured by the first stacker and the second stacker of the plurality of complex facilities in a first direction; and
a second carrier configured to receive the electrode assembly transferred by the plurality of first carriers and to transfer the electrode assembly in a second direction.

14. The facility layout of claim 13, wherein the plurality of complex facilities is disposed such that the plurality of complex facilities is spaced apart from each other by a predetermined distance along the second carrier that extends in the second direction.

15. The complex facility of claim 13, further comprising:
a roll transferring unit configured to transfer a positive electrode sheet roll or a negative electrode sheet roll to the plurality of complex facilities and to be autonomously driven.
